(19) United States
(12) Patent Application Publication
(10) Pub. No.: US 2019/0016433 A1
(43) Pub. Date: Jan. 17, 2019

(54) Low Altitude Persistent Surveillance (LAPS-1) Airship

(71) Applicant: Arman Majidi, Fountain Valley, CA (US)

(72) Inventor: Arman Majidi, Fountain Valley, CA (US)

(21) Appl. No.: 15/998,231

(22) Filed: Mar. 7, 2016

(51) Int. Cl. B64B 1/08; B64B 1/14; B64B 1/30

(52) U.S. Cl. CPC B64B 1/08; B64B 1/30; B64B 1/14

(57) ABSTRACT

The proposed design is of a generally spherical, semi-spherical, cone-shaped, or bell-shaped mini-autonomous airship that has an internal guidance and control system connected to ground operations. The structure of the airship is approximately 2.25 ft in diameter and 2.625 ft in height with a double layered ballonet structure and a gondola on the bottom housing the propulsion, guidance, control, sensor, and communication systems. This unique mini-airship serves to provide persistent low-altitude low-cost surveillance. The airship has a propulsion and control system that permits it to rise over a desired loitering location, and to be maintained in that location for a period of time. In one embodiment the airship may achieve neutral buoyancy when the internal envelope is about 60% full of lifting gas, and may have a service ceiling of about 100 meters. The airship has an equipment module that can include either communications equipment, or monitoring equipment, or both. The airship can be remotely controlled from a ground operator. The airship has electric motors for propulsion and control systems that are driven by power obtained from these motors and systems.

### BACKGROUND OF THE INVENTION

### 1. Field of the Invention

### Class 244, Aeronautics and Astronautics

24 Aircraft, lighter-than-air:
This subclass is indented under the class definition. Miscellaneous aircraft which ordinarily have a total weight less than or equal to that of the volume of air which they displace and are therefore sustained by their buoyancy with respect to the air.

26 Airship and helicopter sustained:
This subclass is indented under subclass 24. Propelled aeronautical machines sustained by their buoyancy relative to the air, having also provision for sustentation or vertical lift by means of screw propellers arranged to develop a substantial component of thrust in a vertical direction.
   (1) Note. For helicopters having also sustaining wings, see this class, subclass 6.
   (2) Note. For helicopters without airplane wings, see this class, subclasses 17.11+.

30 Airships:
This subclass is indented under subclass 24. Propelled aeronautical machines sustained by their buoyancy relative to the air.

2. Description of Related Art

A number of concepts for high altitude platforms already exist, such as high altitude balloons, large blimps or dirigibles, unmanned heavier-than-air aircraft (drones) with both conventional and fixed-wing configurations. Heavier-than-air platforms lack the endurance capabilities required for long-term surveillance, and these systems rely heavily on the flow of air to provide lift and enable controls. Maintaining velocity on control surfaces worsens with the reduction in atmospheric density in higher altitudes. Free balloons or tethered balloons are not suitable to security and surveillance. Free balloons are not stationary without tether. Tethered balloons may not be practicable due to the weight of the tether.

Traditional airships tend to be low altitude and seldom reach altitudes above 5000 ft. Modern airships that rely on the buoyancy of a lifting gas may suffer from a number of disadvantages. Maneuverability of traditional airships tends to rely on the design and structural characteristics. Embodied in an elongated-cone shape with fins to correctly direct airflow for control. Below 10-15 km/h there is insufficient airflow over control surfaces making these systems ineffectual. Due to the large size of conventional lighter-than-air structures more than 20 ground crew operators must assist the pilot with takeoff and landing and these platforms require increasingly larger fields for operations, and due to design the storage and maintenance of these platforms is expensive. The effect of these disadvantage are eliminated with the proposed design.

### SUMMARY OF THE INVENTION

Many experts and officials are concerned with security and surveillance. In a number of applications it would be desirable to have a long-term stationary low altitude platform to provide continuous monitoring, which is particularly important for security and continuous monitoring. The proposed light-weight low-altitude mini-airship will be nearly completely silent with minimal costs for development and operation.

One known kind of stationary high altitude platform is a geo-stationary satellite at nearly 36,000 km above the earth's surface. While these platforms have large “footprints” that can observe vast areas all over the world, these systems may not provide the desired high-resolution imagery and are highly expensive to develop and launch. Non-stationary low earth orbit (LEO) satellites are also available but only hover over a given point momentarily. Therefore, it is advantageous to develop long-term stationary, low altitude, low cost, and low complexity remotely controlled surveillance platforms.

The spherical description of the present system has a double-enveloped hull structure. The double hull will retain the lifting gas better resulting in estimated sustainable flight times of nearly 2 weeks. The outer hull structure provides load bearing and resistance to deformations. The inner two-layered hexagonal hull functions to retain the lifting gas. The proposed platform will have a 100 meter ceiling to avoid commercial or other airspace and will not incur any pressurization issues due to its low flight ceiling. The platform will be no more than 2.25 ft in diameter and 2.625 ft in height. This provides 8-9 cubic ft of interior volume providing a payload capability of nearly 0.5 lbs. The resulting system will provide persistent long-term low altitude surveillance over a 3-5 km radius area over a long period of time.

### BRIEF DESCRIPTION OF THE DRAWINGS

The principles of the various aspects of the invention may better be understood by reference to the accompanying illustrative figures which depict features of examples of embodiments of the invention, in which

FIG. 1. is a low altitude, front elevation of an inflated airship according to an aspect of the present invention;

FIG. 2. is an internal view of the various components parts of the inflated airship according to an aspect of the present invention including the inflated ballonet hull structure (Component 1) that has an inner hexagonal double layered elastic and a deformation-resistant outer hull, and the gondola housing the control system, communications devices, and various sensors (Component 2).

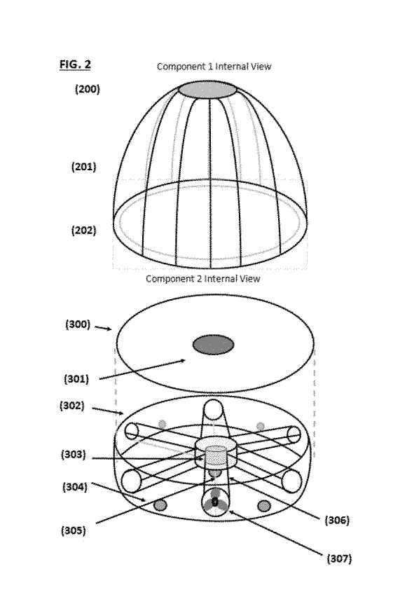

FIG. 3. is a view of an inflated airship 100 meter above sea level according to an aspect of the presented invention and method of low altitude persistent surveillance.

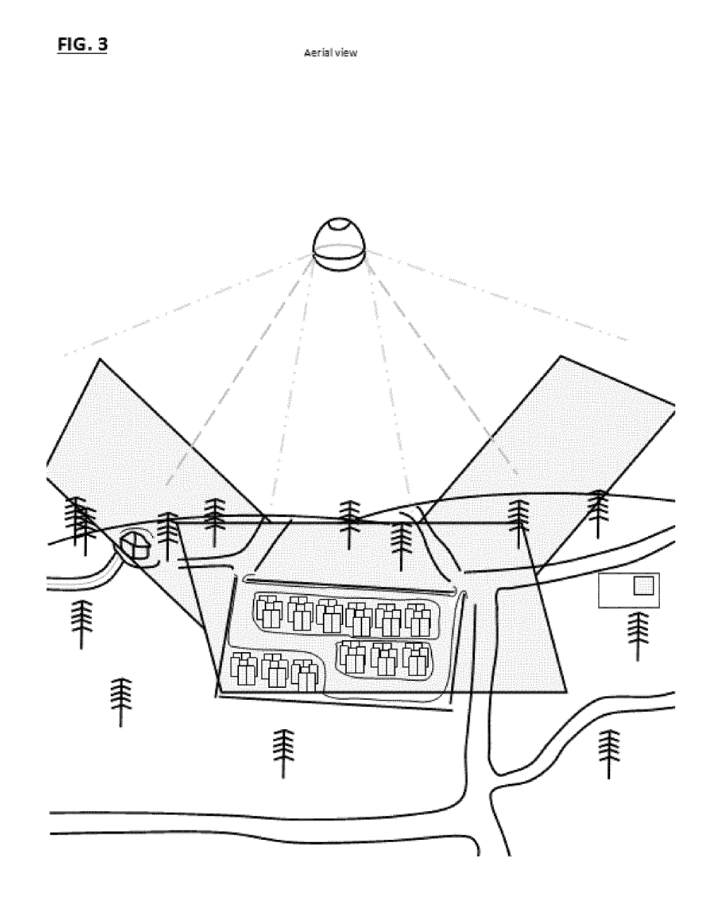

### DETAILED DESCRIPTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawing with the same respective reference numerals. The drawings are not necessarily to scale and in some instances proportions may have been exaggerated in order more clearly to depict certain features of the invention.

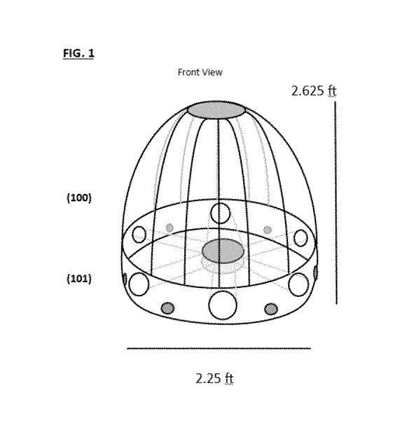

In the embodiment of FIG. 1. a generally spherical, semi-spherical, cone-shaped, or bell-shaped mini-airship has an outer load bearing hull envelope and a double-layer hexagonal shaped inner envelope containing the lifting gas. The outer envelope is made of an array of high strength fabric panels, sewn or heat welded together. Housed within the outer hull is the rigid or semi-rigid internal skeleton made of high strength, low weight poles or ribs, screwed, sewn, or heat welded to both inner and outer envelopes. The inner envelope is made of an array of highly flexible elastic material, and contains the lifting gas. The inner envelope acts as a laminated bladder, or gas bag, containing a fluid in the nature of a lifting gas, such as hydrogen or helium, and fully expandable to provide buoyancy. An electric blower or fan, 301 is located on the outer envelope, and has an intake which draws air from ambient, and outlets that discharge into the inner envelope. The design volume of the outer envelope is large enough to allow for full expansion, plus the internal volume of the payload and operating equipment. While the dumping of lifting gas is rather undesirable, in extreme contingencies that excessive buoyancy has been acquired, blower 301 houses a dump valve to permit dumping of the lifting gas.

In the embodiment of FIG. 1. a generally spherical, semi-spherical, cone-shaped, or bell-shaped mini-airship has a gondola structure made of and array of high strength, transparent and semi-transparent, fabric panels, sewn of heat welded together. Propulsion if provided by a series of symmetrically mounted propulsion devices, in the nature of propeller 307 that are mounted within the gondola structure. Propeller 307 and others are driven by electric motors matched at variable speeds. Current for these electric motors is drawn from a storage element in the nature of a battery. Propellers may be rigidly mounted in an orientation permitting vertical operation in forward or reverse to cause airship to ascend and descend while also allowing an orientation permitting horizontal motion and turning. In the instance when propellers are mounted in a rigid orientation to control ascent and descent as well as horizontal movement in all directions, a small sideways mounted, maneuverable, variable direction yaw thrust flap is mounted to the leading edge portion of propeller housings of the airship. Alternatively, propellers may be mounted on pivoting heads that are capable of being rotated from 0 to 90 degrees in every direction.

### Control Module

The lower region of the airship, or gondola 101, houses an equipment holster sewn generally inwardly of the otherwise generally spherical surface of the outer hull. This equipment holster houses a control module connected to operating motors, sensors, and communication devices, hence controlling guidance, direction, and monitoring. In addition, the control module is designated as operable to control inflation of the gas bag to bleed lifting gas in the event of extreme circumstances. The Control module is connected to a communication and sensor array by which control and equipment monitoring signals are sent to a remotely located control station. Control module is also connected to sensors for surveillance and monitoring, as well as sensors for measuring external ambient temperature and pressure; for measuring current and voltage; for measuring gas bag supply; for measuring stored charge; for measuring motor current draw; antenna for receiving global positioning system or other telemetry data; and for measuring relative air speed. Inputs from the various sensors are used to permit the controlling station to be aware of the status of the airship as well as permitting control of the operation of the airship.

### Equipment Module

The lower region of the airship, or gondola 101, houses an equipment pallet sewn generally inwardly of the otherwise generally spherical surface of the outer hull below the control module. The equipment pallet can serve as a base for equipment and sensors used for one of several functions. The equipment pallet can serve as a communications relay platform, whether for sending and receiving of messages and information, and/or merely acting as a reflector for messages, or for acting as a relay for transmissions operable to boost transited messages and retransmit in case of error. The equipment pallet can also provide a platform for one or more of (a) communications monitoring equipment, (b) thermal imagery equipment, (c) photographic equipment, (d) radar, (e) infrared and near-infrared sensing equipment, (f) pollution sensing equipment, and (g) temperature sensing equipment, (h) humidity sensing equipment, (i) radio frequency sensing equipment, and (j) electro-magnetic sensing equipment.

1. A generally spherical, semi-spherical, cone-shaped, or bell-shaped mini-airship comprising of an outer hull structure with a non-rigid, semi-rigid, or rigid skeleton and an internal envelope, said airship having a buoyancy apparatus operable to maintain said airship aloft, an integrated propulsion and directional apparatus to control said airship; and an internal controller system with communication capabilities to an operator.

2. The generally spherical, semi-spherical, cone-shaped, or bell-shaped mini-airship of claim 1 wherein said propulsion apparatus includes a push propeller.

3. The generally spherical, semi-spherical, cone-shaped, or bell-shaped mini-airship of claim 2 wherein said push propeller operates between 0-250 r.p.m.

4. The generally spherical, semi-spherical, cone-shaped, or bell-shaped mini-airship of claim 2 wherein said push propeller has a top speed of less than 300 ft/s.

5. The generally spherical, semi-spherical, cone-shaped, or bell-shaped mini-airship of claim 2 wherein said push propeller is powered by an electric motor.

6. The generally spherical, semi-spherical, cone-shaped, or bell-shaped mini-airship of claim 1 wherein at least one of said propulsion and directional apparatus includes an internal guidance system.

7. The generally spherical, semi-spherical, cone-shaped, or bell-shaped mini-airship of claim 1 wherein said airship contains an internal battery.

8. The generally spherical, semi-spherical, cone-shaped, or bell-shaped mini-airship of claim 1 wherein said airship contains a control apparatus and communication apparatus with network connections to operations through a networking provider chosen from the set of network providers capable of performing at least one of (a) the ability to carry communications to said airship, (b) the ability to carry communications from said airship, (c) the ability to transmit alerts generated from internal control systems.

9. The generally spherical, semi-spherical, cone-shaped, or bell-shaped mini-airship of claim 8 wherein said control apparatus contains an internal guidance system.

10. The generally spherical, semi-spherical, cone-shaped, or bell-shaped mini-airship of claim 8 wherein said control apparatus contains a storage and processing system.

11. The generally spherical, semi-spherical, cone-shaped, or bell-shaped mini-airship of claim 8 wherein said communication apparatus includes communications operable to perform at least one of (a) receiving communication signals, (b) sending communication signals, (c) relaying communications signals, and (d) reflecting communications signals.

12. The generally spherical, semi-spherical, cone-shaped, or bell-shaped mini-airship of claim 1 wherein said airship includes various surveillance and sensor equipment.

13. The generally spherical, semi-spherical, cone-shaped, or bell-shaped mini-airship of claim 12 wherein said surveillance equipment is chosen from the set of surveillance and sensor equipment consisting of at least one of (a) communications monitoring equipment, (b) thermal imagery equipment, (c) photographic equipment, (d) radar, (e) infrared and near-infrared sensing equipment, (f) pollution sensing equipment, and (g) temperature sensing equipment, (h) humidity sensing equipment, (i) radio frequency sensing equipment, and (j) electro-magnetic sensing equipment.

14. The generally spherical, semi-spherical, cone-shaped, or bell-shaped mini-airship of claim 1 wherein said airship has a cowling consisting of at least one of (a) substantially transparent material, (b) semi-permeable material, (c) transparent material.

15. The generally spherical, semi-spherical, cone-shaped, or bell-shaped mini-airship of claim 14 wherein said airship has, within said cowling, at least one of:
(A) Communications equipment operable to perform at least one of: (a) receiving communications signals, (b) sending communications signals, (c) relaying communications signals, and (d) reflecting communications signals, and
(B) Surveillance and sensor equipment consisting of least one of (a) communications monitoring equipment, (b) thermal imagery equipment, (c) photographic equipment, (d) radar, (e) infrared and near-infrared sensing equipment, (f) pollution sensing equipment, and (g) temperature sensing equipment, (h) humidity sensing equipment, (i) radio frequency sensing equipment, and (j) electro-magnetic sensing equipment.

16. The generally spherical, semi-spherical, cone-shaped, or bell-shaped mini-airship of claim 1 wherein said airship is remotely operated through its control apparatus.

17. The generally spherical, semi-spherical, cone-shaped, or bell-shaped mini-airship of claim 1 wherein said airship contains:
(A) an outer hull structure for resistance and load-bearing;
(B) buoyancy apparatus operable to maintain said airship aloft, and
(C) propulsion and directional apparatus co-operable to control and conduct said airship, wherein said propulsion includes a push propeller driven by an electric motor.

18. A method of operating a buoyant low altitude mini surveillance airship comprising of:
(A) providing a mini airship of semi-spherical, cone-shaped, or bell-shaped, said airship having internal volume and weight, said airship including an outer hull for resistance and load-bearing, said airship having an internal semi-rigid, non-rigid, or rigid skeleton, said airship having an inner inflatable envelope, said airship maintaining an internal envelope layer defined by the outer hull and housed within the internal volume, and said airship having a propulsion and directional control system with a communication apparatus;
(B) maintaining volume relative to external, ambient pressure to maintain buoyancy and rigidity;
(C) inflating the inner, inflatable envelope with a lifting gas or fluid to a first volume sufficient to at balance said weight, said volume, at sea level, being less than 70% of said volume;
(D) operating said propulsion and directional control systems to a location less than 120 meters above sea level;
(E) said airship having communications capabilities through a networking system, and
(F) said airship being remotely controlled and operated.

19. The method of claim 18 wherein said method includes the step of maintaining persistent low altitude long-term surveillance.

20. The method of claim 19 wherein said step of maintaining persistent low altitude long-term surveillance includes the step of maintaining lateral and longitudinal position variation relative to a deviation radius of 20 meters.

21. The method of claim 20 including maintaining said airship at an altitude of less than 120 meters.

22. The method of claim 18 and further including at least one of the steps chosen from the set of steps consisting of:
(A) operating as a communications platform to do at least one of (a) receiving communications signals, (b) sending communications signals, (c) relaying communications signals, and (d) reflecting communications signals, and
(B) operating as a surveillance platform to (a) monitoring communications, (b) take thermal imagery, (c) take photographs, (d) operate radar, (e) take infrared and near-infrared imagery, (f) obtain pollution readings, (g) obtain temperature readings, (h) obtain humidity readings, (i) receive radio waves, and (j) receive electro-magnetic waves.

23. The method of claim 18 including the step of controlling operation of said buoyant airship from a remote location.
